(19) United States
(12) Patent Application Publication
(10) Pub. No.: US 2009/0180662 A1
(43) Pub. Date: Jul. 16, 2009

(54) AUDIO DEVICE AND METHOD FOR ACQUIRING KNOWLEDGE OR INFORMATION

(76) Inventor: MARTY L. PARKER, Plain City, OH (US)

Correspondence Address: James Ray & Associates, 2640 Pitcairn Road, Monroeville, PA, 15146, US

(21) Appl. No.: 12/352,169

(22) Filed: Jan. 12, 2009

Related U.S. Application Data
(60) Provisional application No. 61/015,706, filed on Jan. 10, 2008.

(51) Int. Cl. H04R 1/02

(52) U.S. Cl. 381/394

(57) ABSTRACT

An audio apparatus includes a hollow base having one closed end and an opposed open end and a peripheral flange partially closing the open end. A hollow cover having a first portion thereof mounted within the peripheral flange and caged thereby for a linear movement relative thereto in a direction toward to and away from the closed end and having a second portion thereof extending outwardly from the peripheral flange. A controller and a speaker are mounted within a cavity formed by a combination of the hollow base and the hollow cover and coupled to a source of electric power for outputting a predetermined plurality of audible messages. A resilient membrane is provided for biasing the cover away from the closed end of the base. The audio apparatus enables the user to acquire a single unique morsel of knowledge and/or information on a daily basis for prolong period of times.

### CROSS-REFERENCE TO RELATED APPLICATIONS

This application is related to and claims priority from Provisional Patent Application Ser. No. 61/015,706 filed on Jan. 10, 2008.

### FIELD OF THE INVENTION

The present invention relates, in general, to audio devices and, more particularly, this invention relates to an audio apparatus capable of outputting plurality of pre-recoded unique audio messages, each for a pre-selected duration of time controlled by an internal clock and, yet more particularly, the instant invention relates to a method of using the above device for acquiring knowledge in small increments on a daily basis and for prolong periods of time.

### BACKGROUND OF THE INVENTION

As is generally well known, when a person seeks to acquire a distinct single tid-bit of information or knowledge, whether for recreational, religious, inspirational or educational purposes, on a daily basis, such person must either read a book or a printed publication, use audio and/or video playing devices, or browse the Internet. All of the above methods require greater than desirable time and effort by the user to access needed information.

Prior to the conception and development of the present invention, efforts have been made to alleviate difficulties of acquiring knowledge and information.

For example, U.S. Publication No. 2003/0058752 published to Birnbach provides an apparatus and a corresponding method for delivering a pre-recorded psycho-suggestive message to a person that involves a personal electronic device configured to deliver a new and unique message on a daily basis disabling its normal function during such message delivery.

U.S. Publication No. 2007/0079409 published to Tabron provides an apparatus directed to a motivational tree designed to inspire, educate, encourage, uplift, and/or motivate persons of any age. The motivational tree includes a foliage portion have a plurality of leaves, a trunk having a plurality of extending branches a first end to which the plurality of leaves are attached and a soil area on a second end, and a pot portion that is securely connected to the soil area of said trunk, wherein the pot portion includes a playback circuit that outputs an audible motivational message when activated by one of the plurality of leaves. The playback circuit includes a communication port that provides the capability to download motivational message data from an external processor that may be connected to a network. Further, the playback circuit has a memory device that includes internal memory and a removable memory.

U.S. Publication No. 2006/0057547 published to Donley discloses an electronic motivational apparatus that includes a clock module providing a signal representing time of day. The apparatus also includes a plurality of message modules, each associated with a plurality of messages. A selector module, based on the clock module signal, selects a message module and one of the messages associated with the selected message module. A sound module delivers the selected message.

U.S. Pat. No. 6,947,352 issued to Goolkasian teaches a desktop sound producing device for playing audio recordings from pre-recorded media having a plurality of individual selections recorded thereon. The device has a pyramid shaped housing having four side walls extending upward from a bottom wall to an apex forming a cavity therein. A playback mechanism is positioned within the cavity, and includes a means for storing pre-recorded media, and a processing means capable of providing an audio output signal from the pre-recorded median and amplifying the audio output signal for reproduction of the pre-recorded media through a speaker. The processing means can include an optical scanning system for reading pre-recorded media located on a compact disk. A control panel extends outwardly from one of the walls and includes a plurality of depressible keys electrically coupled to the processing means, wherein at least one of the keys is available for playing a single selection from the pre-recorded media. The control panel further includes and at least one said key coupled to a memory means for replaying a selected selection from the pre-recorded media.

U.S. Pat. No. 6,022,262 issued to Gill discloses a playback mechanism including housing and a plurality of components each mounted on the housing. Such components include a speaker for transmitting audible signals via free space and a memory connected to the speaker for transmitting the audible signals therefrom. Connected to the memory is an activation switch for playing back audio signals only during the actuation thereof.

However, it has been determined that there is a continuing need for a simple and economical apparatus and method for acquiring knowledge of and/or information.

### SUMMARY OF THE INVENTION

The invention provides an audio apparatus that comprises a unitary hollow base. The unitary base includes a peripheral side wall having each of a first uniform thickness throughout, a predetermined length and a predetermined cross-sectional shape in a direction substantially transverse to the predetermined length. A bottom wall closes one end of the base and has a second uniform thickness throughout. The peripheral side wall tapers upwardly and outwardly relative to an inner surface of the bottom wall. A predetermined plurality of first elongated bosses are disposed in a predetermined pattern on the inner surface of the bottom wall and extending in a direction toward an opposed open end of the base. Each of the predetermined plurality of first elongated bosses has a predetermined length and a longitudinal aperture formed therethrough and through the bottom wall. A predetermined plurality of reinforcing ribs are also provided. Each of the predetermined plurality of reinforcing ribs having one edge thereof abuttingly engages an inner surface of the peripheral side wall and has one end thereof abuttingly engaging the inner surface of the bottom wall. A generally closed chamber is disposed on the bottom wall. An aperture is formed through the bottom wall and defines an open end of the chamber. A predetermined plurality of speaker apertures are formed in a predetermined pattern through the bottom wall. An annular ring is disposed on the inner surface of the bottom wall in alignment with and surrounding the predetermined plurality of speaker apertures. A switch aperture is formed through the bottom wall in a predetermined position thereof. The audio apparatus further comprises a unitary peripheral flange partially closing the open end of the base. The peripheral flange includes an upper portion disposed in the direction transverse to the peripheral side wall. An aperture is centrally formed through the upper portion and defines an inner edge thereof. A first peripheral lip is disposed on a bottom surface of the upper portion adjacent to and spaced from an outer edge thereof. The first peripheral lip extends outwardly a first predetermined height relative to the bottom surface of the upper portion. The first peripheral lip is sized to operatively fit within the peripheral side wall of the base. A second peripheral lip is also disposed on the bottom surface of the upper portion in alignment with an inner edge thereof. The second peripheral lip extends outwardly a second predetermined height relative to the bottom surface of the upper portion. There is at least one tab disposed on and extending from a bottom edge of the second peripheral lip. There is also a predetermined plurality of second elongated bosses disposed on the bottom surface of the upper portion in alignment with the predetermined plurality of first elongated bosses and extending in a direction toward the closed end of the base. Each of the predetermined plurality of second elongated bosses has a predetermined length and a longitudinal bore formed in a distal end thereof. A predetermined plurality of third elongated bosses are disposed in a predetermined pattern on the bottom surface of the upper portion and extending in the direction toward the closed end of the base. Each of the predetermined plurality of third elongated bosses has a predetermined length and a longitudinal bore formed in a distal end thereof. The audio apparatus additionally comprises a hollow cover. The hollow cover includes a first portion having exterior surface thereof sized to fit within the second peripheral lip of the peripheral flange so as to be guided during reciprocal linear motion relative to the second peripheral lip in a direction substantially perpendicular to the bottom wall. There is also a second portion extending outwardly from a first peripheral edge of the first portion and having a substantially spherical shape. A third peripheral lip is provided and is disposed transverse to the first portion on an opposed second peripheral edge thereof and positioned to abuttingly engage the bottom edge of the second peripheral lip of the peripheral flange. A forth elongated boss is centrally disposed on and extends outwardly from an interior surface of the second portion of the cover. At least one notch is formed through the peripheral lip of the cover and sized to receive the at least one tab of the second lip of the peripheral flange. A controller is also provided and includes a printed circuit board, a processor mounted on the printed circuit board, a memory mounted on the printed circuit board and coupled to the processor for digitally storing a predetermined plurality of audible messages, a plurality of apertures formed through the printed circuit board in alignment with the predetermined plurality of third elongated bosses so that the printed circuit board is releaseably securable with fasteners thereto, and a first switch mounted on the printed circuit board in alignment with the forth elongated boss to be actuated thereby when a manual force is applied to the cover causing the linear movement thereof in the direction toward the bottom wall. There is a resilient membrane affixed to the printed circuit board and having a portion thereof disposed between the first switch and a distal end of the third boss so as to return the cover to a normal position when the manual force is removed. A speaker is mounted within the annular ring of the base and is coupled to the processor. At least one battery is disposed within the chamber. A battery cover operatively closes the open end of the chamber. At least one pair of electric contacts are operatively mounted within walls of the chamber for operatively engaging the at least one battery and are coupled to the controller for supplying electric power thereto. A second switch is mounted on the interior surface of the bottom wall and having a linearly movable actuating portion thereof extending into the switch aperture.

The present invention also provides a method of acquiring at least one of knowledge and information. The method includes the steps of arranging a predetermined plurality of audible messages in a predetermined order. Then, providing an apparatus for outputting such predetermined plurality of audible messages arranged in said predetermined order each associated with a predetermined period of time. Next, activating the apparatus by a person acquiring such at least one of knowledge and information. Finally, outputting, by the apparatus a distinct one from the predetermined plurality of audible messages within such predetermined period of time.

### OBJECTS OF THE INVENTION

It is, therefore, one of the primary objects of the present invention to provide an audio apparatus capable of outputting plurality of pre-recoded unique audio messages, each for a pre-selected duration of time controlled by an internal clock.

Another object of the present invention is to provide an audio apparatus that is simple to use.

Yet another object of the present invention is to provide an audio apparatus that is economical to manufacture.

A further object of the present invention is to provide an audio apparatus that is capable of accepting removable media storage device containing a unique set of a plurality of pre-recoded unique audio messages.

Yet a further object of the present invention is to provide a method of using the above apparatus for acquiring knowledge or information.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates an exploded isometric view of an audio apparatus of the present invention;

FIG. 2 is an elevation view of the apparatus of FIG. 1;

FIG. 3 is a bottom view of the apparatus of FIG. 1;

FIG. 4 illustrates a peripheral flange member of the apparatus of FIG. 1;

FIG. 5 is a partial view of the apparatus of FIG. 2, particularly illustrating fit of the cover of the present invention;

FIG. 6 is a partial view of the apparatus of FIG. 2, particularly illustrating cover biasing means of the present invention; and

FIG. 7 is a schematic block diagram of the apparatus of FIG. 1.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of an audio message applies to content related to spiritual, educational, motivational, trivia, self-improvement, self-awareness and the like fields for the purpose of acquiring knowledge and/or information.

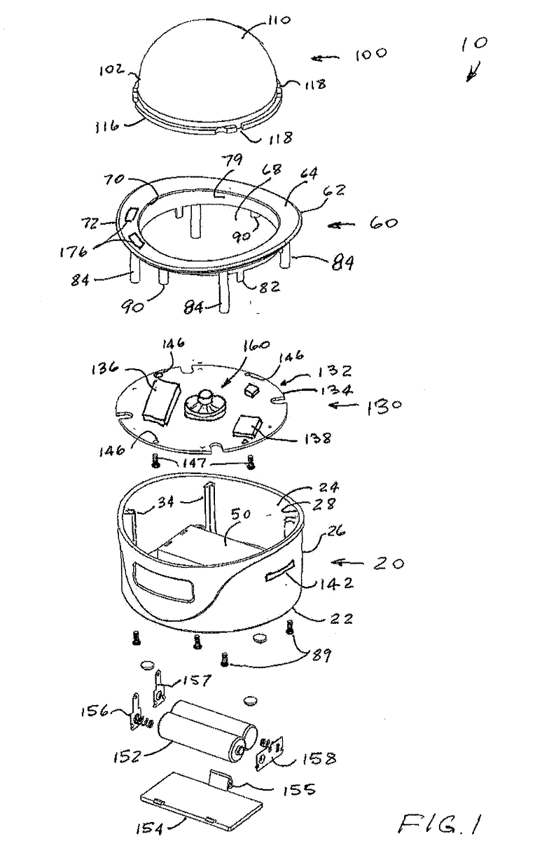

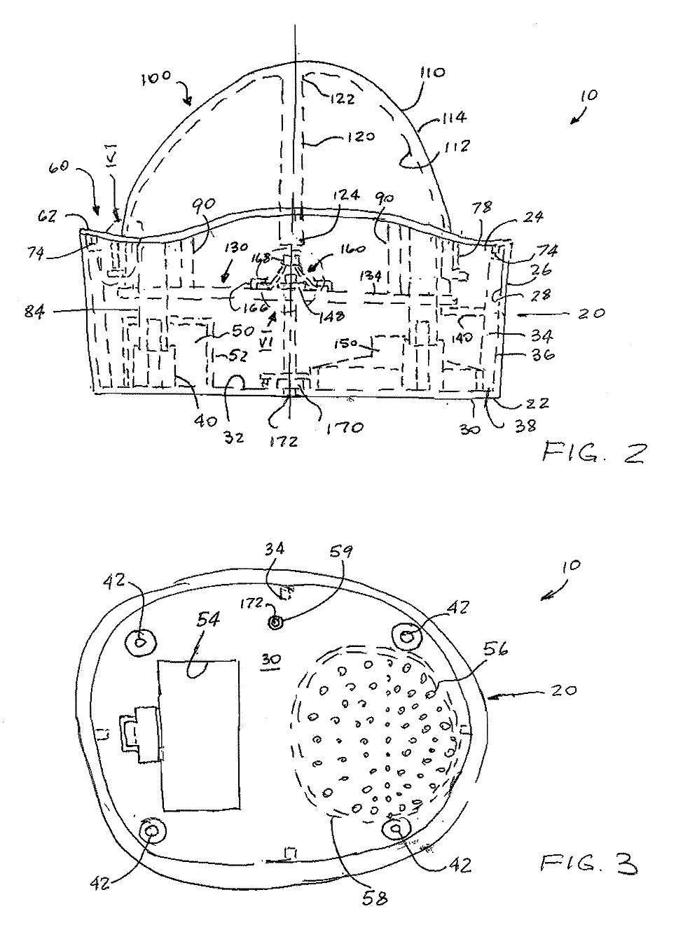

The best mode for carrying out the invention is presented in terms of its presently preferred embodiment, herein depicted within FIGS. 1 through 7. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention essentially provides an audio apparatus, generally designated as 10 that includes the following essential elements: a hollow base, generally designated as 20, a peripheral flange, generally designated as 60, a hollow cover, generally designated as 100, means, generally designated as 130, mounted within a cavity formed by a combination of the hollow base 20 and the hollow cover 100 and coupled to a source of electric power for outputting a predetermined plurality of audible messages and a biasing means, generally designated as 160, for biasing the cover 100 outwardly from the base 20.

The audio apparatus 10 of the present invention enables the user to acquire a single unique morsel of knowledge and/or information on a daily basis for prolong period of times, preferably such as a year, with a simple and single hand motion eliminating the need for activating a plurality of control switches and reducing effort and time associated therewith.

Reference is now made, to FIGS. 1-7, wherein the hollow base 20 is shown as having a closed end 22 and an axially opposed open end 24. There is also a peripheral side wall 26 having each of a first uniform thickness throughout, a predetermined length and a predetermined cross-sectional shape in a direction substantially transverse to the predetermined length. The presently preferred predetermined cross-sectional shape is round, although other cross-sections are also within the scope of the present invention. The closed end 22 is closed by a bottom wall 30 having a second uniform thickness throughout. Preferably, the thickness of the bottom wall 30 is substantially identical to the thickness of the peripheral wall 26. The peripheral side wall 26 preferably tapers slightly upwardly and outwardly relative to an inner surface 32 of the bottom wall 30 to enhance rigidity of the base 20. The base 20 may be further adapted with a predetermined plurality of reinforcing ribs 34, each of the predetermined plurality of reinforcing ribs 34 having one edge 36 thereof abuttingly engaging an inner surface 28 of the peripheral side wall 26 and having one end 38 thereof abuttingly engaging the inner surface 32 of the bottom wall 30.

There is also a predetermined plurality of first elongated bosses 40 disposed in a predetermined pattern on the inner surface 32 of the bottom wall 30 and extending in a direction toward an opposed open end 24 of the base 20. Each of the predetermined plurality of first elongated bosses 40 has a predetermined length and a longitudinal aperture 42 formed therethrough and through the bottom wall 30. A bore 46 is formed axially in a distal end 44 of each first elongated boss 40.

Any material of the base 20 is contemplated for use within present invention with the plastics materials being presently preferred for the sake of weight and cost advantages.

For the reasons to be explained later, the base 20 has the following features. A generally closed chamber 50 disposed on inner surface 32 of the bottom wall 30 and defined by a peripheral wall 52. An aperture 54 that is formed through the bottom wall 30 providing an open end of or access to the chamber 50. A predetermined plurality of speaker apertures 56 formed in a predetermined pattern through the bottom wall 30. An annular ring 58 that is also provided and is disposed on the inner surface 32 of the bottom wall 30 in alignment with and surrounding the predetermined plurality of speaker apertures 56. A switch aperture 59 is formed through the bottom wall 30 in a predetermined position thereof.

In further reference to FIGS. 1 and 4, the peripheral flange 60, preferably provided as a unitary member, partially closes the open end 24 of the base 20. The peripheral flange 60 includes an upper portion 62 disposed in the direction transverse to the predetermined length of the peripheral side wall 26. The upper portion 62 has a top surface 64 and a bottom surface 66. The upper portion 62 has an aperture 68 centrally formed therethrough and defining a ring like peripheral flange with inner peripheral edge 70 and an outer peripheral edge 72.

A first peripheral lip 74 is disposed on the bottom surface 66 of the upper portion 62 adjacent to and spaced from the outer peripheral edge 72 thereof. The first peripheral lip 74 extends outwardly a predetermined height relative to the bottom surface 66 of the upper portion 62. Since the presently preferred base 20 has a round shape, the first peripheral lip 74 is annular. The predetermined height and outer diameter of the first peripheral lip 74 are sized to operatively fit within the peripheral side wall 26 of the base 20. The predetermined height of the first peripheral lip 74 can be relatively small, even less than 0.13 inches, enough to locate the peripheral flange 60 within the base 20. A small clearance between the outer surface 76 of the first peripheral lip 74 and the inner surface 28 of the peripheral wall 26 is contemplated so as to prevent interference during assembly.

A second peripheral lip 78 is also provided and is also disposed on the bottom surface 66 of the upper portion 62 in general alignment with an inner peripheral edge 70 thereof. The second peripheral lip 78 is substantially straight and its inner surface 79 is substantially smooth so as to define a cylinder. The second peripheral lip 78 extends outwardly a predetermined height relative to the bottom surface 66 of the upper portion 62. At least one and, preferably, a plurality of tabs 82 are disposed on and extend outwardly from a bottom edge 80 of the second peripheral lip 78.

The peripheral flange 60 also includes a predetermined plurality of second elongated bosses 84 disposed on the bottom surface 66 of the upper portion 62 and extending in a direction toward the closed end 22 of the base 20 in alignment with the predetermined plurality of first elongated bosses 40. Each of the predetermined plurality of second elongated bosses 84 has a predetermined length and a longitudinal bore 88 formed in a distal end 86 thereof. During assembly, each bore 88 aligns with a respective aperture 42 of the first elongated boss 40 so that the peripheral flange 60 can be secured to the base 20 with fasteners 89. The distal end 86 is operatively received within the respective bore 46.

There is also a predetermined plurality of third elongated bosses 90 disposed in a predetermined pattern on the bottom surface 66 of the upper portion 62 and extending in the direction toward the closed end 22 of the base 20. Each of the predetermined plurality of third elongated bosses 90 has a predetermined length and a longitudinal bore 94 formed in a distal end 92 thereof.

In further reference to FIGS. 1-2 and 5, the hollow cover 100 includes a first substantially cylindrical portion 102 having an exterior surface 104 thereof sized to operatively fit within the inner surface 79 of the second peripheral lip 78 of the peripheral flange 60. A peripheral clearance, best illustrated in FIG. 5, is provided so that the first portion 102 is adapted for reciprocal linear motion relative to the second peripheral lip 78 in a direction substantially perpendicular to the bottom wall 30 of the base 20.

A second portion 110 extends outwardly from a first peripheral edge 106 of the first portion 102 and has a substantially spherical shape defined by an inner concave surface 112 and an outer convex surface 114. After assembly, the second portion 110 extends outwardly from the base 20.

A third peripheral lip 116 is disposed transverse to the first portion 102 on the opposed second peripheral edge 108 thereof and positioned to abuttingly engage the bottom edge 80 of the second peripheral lip 74 of the peripheral flange 60. A plurality of notches 118 are provided within the lip 116, each positioned and sized to receive a respective one of the predetermined plurality of tabs 82 for preventing rotational motion of the cover 100 during use.

There is also a forth elongated boss 120 which has a proximal end 122 thereof disposed centrally on the inner surface 112 of the second portion 110. An opposed distal end 124 of the third elongated boss 120 extends outwardly in a direction toward the closed end 22 of the base 20.

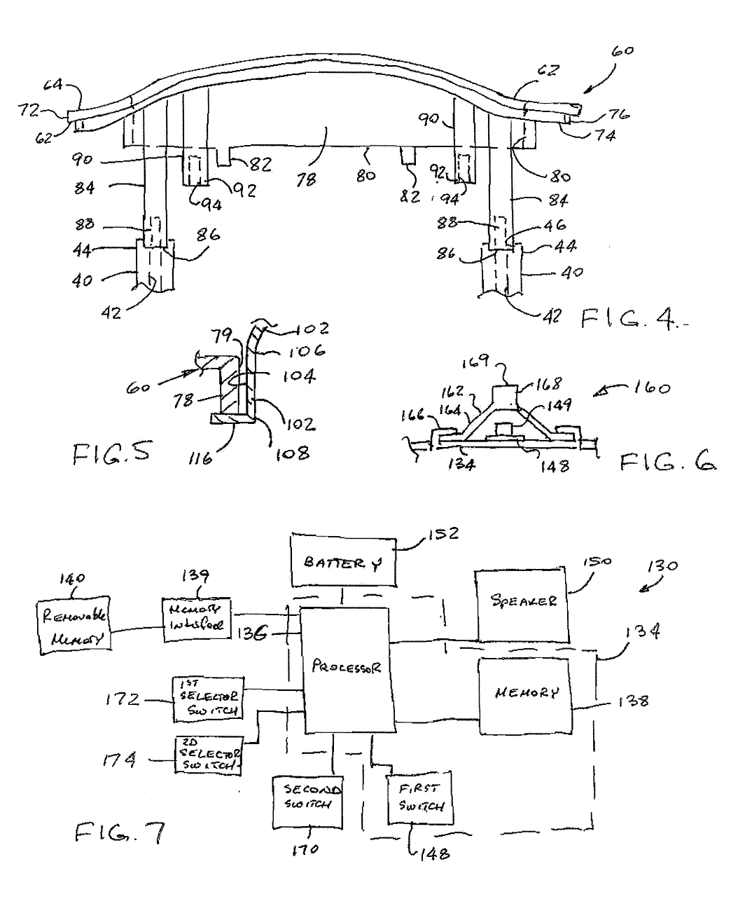

The means 130, best shown in FIGS. 1 and 7, for generating the predetermined plurality of audible messages comprise a controller 132 at least including a printed circuit board 134 and a microprocessor 136 mounted thereon. A memory 138 is also provided and is preferably mounted on the printed circuit board 134 and coupled to the processor 136 for digitally storing the predetermined plurality of audible messages. The presently preferred memory 138 is of an EEPROM type. Although it is within the scope of the present invention to provide a removable memory device 140 operable through the removable memory interface device 139. the removable memory device 140 may have a Universal Serial Bus (USB) interface or be of a flash card type. Such removable memory device 140 may be coupled to the processor 136 through the memory interface device 139 by way of a slot 142 formed, for example, in the peripheral side wall 26.

In the presently preferred embodiment of the invention, the processor 136 is a programmable chip manufactured by Sonix Technology Co., Ltd under SNL310 model. In addition to being a high performance 16-bit base processor, this chip is also a powerful software voice synthesizer to realize hi-compression, 4-channel wave-table melody. Additionally, this processor 136 has a built in real time clock capabilities and has an universal asynchronous receiver transmitter (UART) interface.

A predetermined plurality of apertures 146 are formed through the printed circuit board 134 in respective alignments with the predetermined plurality of third elongated bosses 90 so that the printed circuit board 134 is releaseably securable with fasteners 147 thereto.

A first switch 148 is provided and is preferably mounted on the printed circuit board 134 in alignment with the distal end 124 of forth elongated boss 120 to be actuated thereby when a manual force is applied to the cover 100 causing linear movement thereof in the direction toward the bottom wall 30.

There is also a speaker 150 which is caged within the annular ring 58 of the base 20 in operative alignment with speaker apertures 56. The speaker 150 is coupled to the processor 134 and is operable thereby to output sound. The apparatus 10 may be connected to a standard electric outlet (not shown) and, preferably, the apparatus 10 includes a source of electric power, for example, such as at least one battery 152 mounted within the chamber 50 through the access aperture 54. A battery cover 154 is then provided for selectively opening and closing such chamber 150 and locks by way of the locking tab 155. Also in order to accommodate at least one battery 152, electric contacts 156, 157, and 158 operatively mounted within peripheral wall 52 of the chamber 50 for operatively engaging the at least one battery 152 and are coupled to the controller 132 for supplying electric power thereto.

The biasing means 160 of the presently preferred embodiment of the invention includes a resilient membrane 162, best shown in FIGS. 1-2 and 6, having a first resilient and compressible portion 164 thereof affixed to the printed circuit board 134 with a ring 166 and having a second rigid portion 168 thereof disposed between the first switch 148 and the distal end 124 of the forth elongated boss 120. In operation, linear movement of the cover 100 toward the bottom wall 30 causes the distal end 124 of the forth elongated boss 120 to engage the second rigid portion 168 of the membrane 162 and move it in the same direction to actuate the linearly movable plunger 149 of the first switch 148. At the same time, the first portion 164 of the membrane 162 compresses. When the manual force is removed from the cover 100, the first portion 164 extends moving the second rigid portion 168 in a direction away from the first switch 148 and returning the cover 100 to its normal position. The second portion 168 of the membrane 160 and the forth elongated boss 120 are sized so that the third peripheral lip 116 of the cover 110 abuts the bottom peripheral edge 80 of the second peripheral lip 78 of the peripheral flange 60 while the end 169 of the second portion 168 abuts the distal end 124 of the forth elongated boss 120 in a manner preventing actuation of the first switch 148.

While the controller 132 may be actuated when the at least one battery 152 is coupled thereto, the present invention provides an optional second switch 170 coupled to the controller 132 and operable by a user from an outer surface of the bottom wall 30 of the base 20 for setting the internal real clock of the processor 136. Thus, the user, after installing the at least one battery 152, depresses, for a predetermined period of time, the linearly movable actuating plunger 172 of the second switch 170 extending into the switch aperture 59, thus setting the internal clock and establishing a predetermined duration of time which is presently set at 24 hours.

In operation, when the user operates the second switch 170, the real time clock of the microprocessor 136 is initialized and its internal timing circuit is set for a predetermined duration of time. It is presently preferred to fix such predetermined duration of time at twenty four (24) hours, thus it is beneficial to operate the second switch 170 late in the evening. After the internal timing circuit has been set, the user simply applies slight hand pressure onto the cover 100 moving it in a direction of the bottom wall 30 and activating the first switch 148. Activation of the first switch 148 causes the controller 132 to retrieve a distinct message from the predetermined plurality of messages stored in a digital format within the memory 138 enabling the speaker 150 to output this distinct message in audible form. The microprocessor 136 is presently programmed so that any consequent activations of the first switch 148 within such predetermined duration of time outputs the same message. When such predetermined duration of time associated with a specific distinct message has expired, the timing circuit resets, enabling retrieval of the next message sequentially stored within the memory 138.

In accordance with a presently preferred embodiment of the invention, the controller 132 is programmed to retrieve next sequenced message upon expiration of the predetermined duration of time even if the user did not actuate the first switch 148. However, the present invention also provides optional means for manually selecting at least one audible message from the predetermined plurality of audible messages. Such means may be at least one and preferably a pair of selector switches 172, 174 operable through apertures 176 formed through the upper portion 62 of the peripheral flange 60. One of the pair of selector switches, for example switch 172, enables the user to retrieve at least one previously outputted audible message and an opposed one of the pair of selector switches enables a user to obtain at least one new audible message. Thus, the user who skipped listening to one or several message while being away from the apparatus 10 can use the selector switch 172 to retrieve appropriate number of skipped messages. Furthermore, the user can advance retrieval of messages ahead of the message automatically scheduled for retrieval by using the second switch 174.

It is also within the scope of the present invention to use the method of acquiring at least one knowledge and information with apparatuses or devices having different shape. For example, the controller can be installed within a child's toy and being simply activated by pressure to a pre-selected portion of the toy's surface.

The audio apparatus 10 of the present invention allows people to share inspiration, motivation and knowledge with their children, on a daily and a consistent basis at the touch of a button. It is presently designed for a desk top application, for examples such as sitting on a kitchen table, beside the coffee pot. The speaker 150 is adapted to output sound of intensity suitable to be heard even by a number of people being in general proximity thereof, for example such as students in a classroom.

Another advantage of the audio apparatus 10 of the present invention is in that it eliminates the multiple steps common to arranging a tape cassette, mp3 file, compact disk player, digital video disk player, so that such devices will play information. Specifically such steps include turning on a device, flipping to the right channels, moving a device, opening a device, finding a device, plugging a device into a speaker. The audio apparatus 10 of the present is provided with one simple button and the information to be played is already loaded. All that is required to retrieve the information on a consistent basis is the press of a button.

It has been also found that the single purpose, simplicity of operation and intended use of the audio apparatus 10 in a desk-type application and in open view of the user are advantageous in both reminding and enticing the user to use the audio apparatus 10 on the daily basis for a dose of inspiration or wisdom as compared with other devices, such as a mobile phone or a portable player.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An audio apparatus comprising:
(a) a hollow base having a closed end and an axially opposed open end;
(b) a peripheral flange partially closing said open end of said base;
(c) a hollow cover having a first portion thereof mounted within said peripheral flange and caged thereby so as to be adapted for a linear movement relative thereto in a direction toward to and away from said closed end and having a second portion thereof extending outwardly from said peripheral flange;
(d) means mounted within a cavity formed by a combination of said hollow base and said hollow cover and coupled to a source of electric power for outputting a predetermined plurality of audible messages; and
(e) a biasing means for biasing said hollow cover away from said closed end of said hollow base.

2. The apparatus, according to claim 1, wherein said means for outputting said predetermined plurality of audible messages includes:
(a) a controller at least including:
(i) a printed circuit board,
(ii) a processor mounted on said printed circuit board, and
(iii) a memory mounted on said printed circuit board and coupled to said processor for digitally storing said predetermined plurality of audible messages;
(b) a switch operable by said hollow cover when a manual force is applied to said second portion of said hollow cover causing said linear movement thereof in said direction toward said closed end of said hollow base; and
(c) a speaker.

3. The apparatus, according to claim 2, wherein said memory is at least one of an internal memory and a removable memory device.

4. The apparatus, according to claim 3, wherein said memory is said internal memory mounted on said printed circuit board.

5. The apparatus, according to claim 2, wherein said processor includes a real time clock means disposed therewithin.

6. The apparatus, according to claim 5, wherein said means for outputting said predetermined plurality of audible messages further includes a second switch coupled to said controller and operable by a user from an exterior surface of said base for setting said real time clock means.

7. The apparatus, according to claim 2, wherein said switch is mounted on said printed circuit board.

8. The apparatus, according to claim 1, wherein said device includes said source of electric power.

9. The apparatus, according to claim 8, wherein said source of electric power includes at least one battery mounted within said hollow base.

10. The apparatus, according to claim 1, wherein said biasing means is a resilient compressible member.

11. The apparatus, according to claim 1, wherein said apparatus includes means for manually selecting at least one distinct audible message from said predetermined plurality of audible messages.

12. The apparatus, according to claim 11, wherein said audible message selecting means includes at least one selector switch.

13. The apparatus, according to claim 12, wherein said at least one selector switch is operable from an exposed surface of said peripheral flange.

14. An audio apparatus comprising:
(a) a unitary hollow base including:
(i) a peripheral side wall having each of a first uniform thickness throughout, a predetermined length and a predetermined cross-sectional shape in a direction substantially transverse to said predetermined length,
(ii) a bottom wall closing one end of said base and having a second uniform thickness throughout, wherein said peripheral side wall tapers upwardly and outwardly relative to an inner surface of said bottom wall.
(iii) a predetermined plurality of first elongated bosses disposed in a predetermined pattern on said inner surface of said bottom wall and extending in a direction toward an opposed open end of said base, each of said predetermined plurality of first elongated bosses having a predetermined length and a longitudinal aperture formed therethrough and through said bottom wall,
(iv) a predetermined plurality of reinforcing ribs, each of said predetermined plurality of reinforcing ribs having one edge thereof abuttingly engaging an inner surface of said peripheral side wall and having one end thereof abuttingly engaging said inner surface of said bottom wall,
(v) a generally closed chamber disposed on said bottom wall,
(vi) an aperture formed through said bottom wall and defines an open end of said chamber,
(vii) a predetermined plurality of speaker apertures formed in a predetermined pattern through said bottom wall,
(viii) an annular ring disposed on said inner surface of said bottom wall in alignment with and surrounding said predetermined plurality of speaker apertures, and
(ix) a switch aperture formed through said bottom wall in a predetermined position thereof;
(b) a unitary peripheral flange partially closing said open end of said base, said peripheral flange including:
(i) an upper portion disposed in said direction transverse to said peripheral side wall,
(ii) an aperture centrally formed through said upper portion and defining an inner edge thereof,
(iii) a first peripheral lip disposed on a bottom surface of said upper portion adjacent to and spaced from an outer edge thereof, said first peripheral lip extending outwardly a first predetermined height relative to said bottom surface of said upper portion, said first peripheral lip sized to operatively fit within said peripheral side wall of said base,
(iv) a second peripheral lip disposed on said bottom surface of said upper portion in alignment with an inner edge thereof, said second peripheral lip extending outwardly a second predetermined height relative to said bottom surface of said upper portion,
(v) at least one tab disposed on and extending from a bottom edge of said second peripheral lip,
(vi) a predetermined plurality of second elongated bosses disposed on said bottom surface of said upper portion in alignment with said predetermined plurality of first elongated bosses and extending in a direction toward said closed end of said base, each of said predetermined plurality of second elongated bosses having a predetermined length and a longitudinal bore formed in a distal end thereof, and
(vii) a predetermined plurality of third elongated bosses disposed in a predetermined pattern on said bottom surface of said upper portion and extending in said direction toward said closed end of said base, each of said predetermined plurality of third elongated bosses having a predetermined length and a longitudinal bore formed in a distal end thereof;
(c) a hollow cover including:
(i) a first portion having exterior surface thereof sized to fit within said second peripheral lip of said peripheral flange so as to be guided during reciprocal linear motion relative to said second peripheral lip in a direction substantially perpendicular to said bottom wall,
(ii) a second portion extending outwardly from a first peripheral edge of said first portion and having a substantially spherical shape,
(iii) a third peripheral lip disposed transverse to said first portion on an opposed second peripheral edge thereof and positioned to abuttingly engage said bottom edge of said second peripheral lip of said peripheral flange,
(iv) a forth elongated boss centrally disposed on and extending outwardly from an interior surface of said second portion of said cover, and
(v) at least one notch formed through said peripheral lip of said cover and sized to receive said at least one tab of said second lip of said peripheral flange;
(d) a controller at least including:
(i) a printed circuit board,
(ii) a processor mounted on said printed circuit board,
(iii) a memory mounted on said printed circuit board and coupled to said processor for digitally storing a predetermined plurality of audible messages,
(iv) a plurality of apertures formed through said printed circuit board in alignment with said predetermined plurality of third elongated bosses so that said printed circuit board is releaseably securable with fasteners thereto, and
(v) a first switch mounted on said printed circuit board in alignment with said forth elongated boss to be actuated thereby when a manual force is applied to said cover causing said linear movement thereof in said direction toward said bottom wall;
(e) a resilient membrane affixed to said printed circuit board and having a portion thereof disposed between said first switch and a distal end of said third boss so as to return said cover to a normal position when said manual force is removed;
(f) a speaker mounted within said annular ring of said base and coupled to said processor;
(g) at least one battery disposed within said chamber;
(h) a battery cover operatively closing said open end of said chamber;
(i) at least one pair of electric contacts operatively mounted within walls of said chamber for operatively engaging said at least one battery, said at least one pair of electrical contacts coupled to said controller for supplying electric power thereto; and
(j) a second switch mounted on said interior surface of said bottom wall and having a linearly movable actuating portion thereof extending into said switch aperture.

15. The apparatus, according to claim 14, wherein said apparatus includes a pair of user operable selector switches, wherein one of said pair of selector switches enables a user to retrieve at least one previously outputted audible message and wherein an opposed one of said pair of selector switches enables a user to obtain at least one new audible message.

16. The apparatus, according to claim 15, wherein said pair of user operable selector switches are operable from an exposed surface of said upper portion of said peripheral flange.

17. A method of acquiring at least one of knowledge and information, said method comprising the steps of:
(a) arranging a predetermined plurality of audible messages in a predetermined order;
(b) providing an apparatus for outputting said predetermined plurality of audible messages arranged in said predetermined order each associated with a predetermined period of time;
(c) activating said apparatus by a person acquiring said at least one of knowledge and information; and
(d) outputting, by said apparatus provided in step (b) and activated in step (c), a distinct one from said predetermined plurality of audible messages within said predetermined period of time.

18. The method, according to claim 17, wherein said apparatus includes a hollow base having a closed end and an opposed open end, a peripheral flange partially closing said open end of said base, a hollow cover having a first portion thereof mounted within said peripheral flange and caged thereby so as to provide for a linear movement of said cover relative thereto in a direction toward to and away from said closed end and having a second portion thereof extending outwardly from said peripheral flange, means mounted within a chamber formed by a combination of said hollow base and said hollow cover and coupled to a source of electric power for outputting a predetermined plurality of audible messages, and a biasing means for biasing said cover away from said closed end of said base.

19. The method, according to claim 17, wherein said method includes the additional step of outputting another distinct one from said predetermined plurality of audible message within said predetermined period of time.
